(19) United States
(12) Patent Application Publication
(10) Pub. No.: US 2018/0300738 A1
(43) Pub. Date: Oct. 18, 2018

(54) METHOD AND SYSTEM FOR FORECASTING PRODUCT SALES ON MODEL-FREE PREDICTION BASIS

(71) Applicant: NATIONAL TAIWAN NORMAL UNIVERSITY, Taipei City (TW)

(72) Inventors: Tse-Ping Dong, Taipei City (TW); Lu-Hung Chen, Taichung City (TW)

(73) Assignee: NATIONAL TAIWAN NORMAL UNIVERSITY, Taipei City (TW)

(21) Appl. No.: 15/928,063

(22) Filed: Mar. 21, 2018

(30) Foreign Application Priority Data
Mar. 22, 2017 (TW) 106109444

(51) Int. Cl. G06Q 30/02; G06N 3/08

(52) U.S. Cl. CPC G06Q 30/0202; G06N 3/08

(57) ABSTRACT

The present invention discloses a method and a system for forecasting product sales on a model-free prediction basis, the method comprises establishing a database for storing historical sales data and a variety of variates; providing a preprocessing module for finding major characteristics of sales data from the historical sales data of previous similar products and the corresponding variety of variates thereof stored in the database, and optimizing the major characteristics and coefficients thereof; providing a calculation module for calculating forecast data: substituting covariates to calculate coefficients of a product for forecasting and totalizing the sum of the coefficients of the product for forecasting multiplied by the optimized major characteristics to forecast sales data of the product for forecasting; and providing an output module for outputting the sales data of the product for forecasting. According to the embodiments of the present invention, it is unnecessary for a server to establish a model in order to forecast sales data, which is beneficial to improving forecasting performance of the server.

### CROSS-REFERENCES TO RELATED APPLICATIONS

The present application claims priority to Taiwan Patent Application No. 106109444, filed Mar. 22, 2017, which is incorporated herein by reference in its entirety.

### FIELD OF THE INVENTION

The present invention relates to the field of computer technology, particularly to a method and system for forecasting product sales on model-free prediction basis.

### BACKGROUND OF THE INVENTION

Sales forecasting plays a crucial role in the performance of companies. Inaccurate forecasts may result in stock-out or overstock of inventories, which may cause enormous losses to the companies. However, “sales forecasting” has never been easy because product sales involve many complex and uncertain factors or mechanisms; as a result, we usually have very little information about how the sales are made and why products are purchased. Hence, it is very difficult to develop an accurate set of mathematical models to describe product sales.

Despite the difficulty of sales forecasting, a lot of efforts have been made on this area. Most of the existing methods can be divided into three categories. The first category: people attempt to develop explicit mathematical formulations with specific assumptions to predict future sales. For example, F. M. Bass (1969) suggests a simple diffusion model to describe the sales of a new product, based on the assumption and premise that consumers will not buy more than one piece of the product, i.e., the Bass diffusion model, a sales condition of a new product is described by using this model (A new product growth for model consumer durables. Management Science 15, 215-227); Ishii et al. (2012) introduces a stochastic model to interpret the effect of word-of-mouth (WoM) on product sales (A mathematical model of human dynamics interactions as a stochastic process, New J. Phys. 14). The second category: in this category, time series models, such as exponential smoothing, autoregressive integrated moving average (ARIMA) model, generalized autoregressive conditional heteroskedasticity (GARCH) model, etc., are used to forecast product sales. The third category: machine learning and data mining approaches. For example, Ghiassi et al. (2015) exploits artificial neural network to predict movie revenues (Pre-production forecasting of movie revenues with a dynamic artificial neural network. Expert Systems with Applications 42, 3176-3193); Kulkarni et al. (2012) adopts web search volumes to forecast future sales (Using online search data to forecast now product sales. Decision Support System 52, 604-611).

Unfortunately, all the above approaches rely on certain pre-determined parametric models, but in reality the product sales are usually too complex to be describe by parametric models. For example, neither the Bass diffusion model (Bass, 1969) nor the WoM model (Ishii et al., 2012) are capable of describing the seasonal effect on product sales. Most of the time series models are linear and unable to deal with the asymmetric behavior in sales data (Makridakis et al., 1998, Forecasting methods and applications (3rd ed.), Wiley.). Further, machine learning and data mining approaches try to epitomize sales activities by exploiting more complicated models, however, they usually lead to overfitting and hence are rarely used in practice (Tetko et al., 1995. Neural network studies. 1. comparison of overfitting and overtraining. Journal of Chemical Information and Modeling 35, 826-833; Leinweber, 2007 Stupid data miner tricks: Overfitting the s&p 500. The Journal of Investing 16, 15-22).

Other forecasting approaches, for example, judgement-based method, Bases and Lin model, clustering approaches, etc.

Therefore, the present invention provides a nonparametric model to replace default formulations. In the nonparametric model of the present invention, the most suitable formulation is generated completely by historical data, and the covariates of the variables that are influential to or capable of influencing sales activities are selected automatically without establishing any models by the servers to forecast product sales, which are beneficial to improving forecasting efficiency of the servers.

### DETAIL DESCRIPTION OF THE INVENTION

The purpose of the present invention is to provide a method for forecasting product sales data on a model-free prediction basis, which is characterized by comprising: A. establishing a database for storing records of historical sales data of previous similar products and a variety of variates; B. providing a preprocessing module for processing: b1. finding major characteristics of sales data from the historical sales data and corresponding variety of variates thereof stored in the database, and b2. optimizing the major characteristics and coefficients thereof by using statistical optimization; providing a calculation module for calculating forecast data: c1. substituting covariates of a product to be forecasted to calculate coefficients of the product to be forecasted, and c2. totalizing the sum of the coefficients of the product to be forecasted multiplied by the optimized major characteristics to forecast the product sales data of the product to be forecasted; and D. providing an output module for outputting the sales data of the product to be forecasted.

In one embodiment, wherein the historical sales data are true data.

In one embodiment, wherein the major characteristics are estimated by a statistical component analysis method or an autoencoder.

In one embodiment, wherein the statistical component analysis method is principal component analysis.

In one embodiment, the major characteristics are estimated by singular value decomposition or nonnegative matrix decomposition.

In one embodiment, wherein the statistical optimization method is an estimation of basis pursuit or a nonparametric regression model. In a preferred embodiment, the nonparametric regression model is local polynomial regression or support vector regression.

In one embodiment, wherein the coefficients of the product to be forecasted is estimated according to a fitted sparse single indexed model.

The present invention further provides a method for forecasting product sales data on a model-free prediction bases, which is characterized by comprising: A. establishing a database for storing historical sales values X and a variety of variates of previous similar products; B. providing a preprocessing module for processing: b1. finding major characteristics from records of the historical sales values X and the variety of variates of previous similar products,

b2. providing formula I,

X(t|Z)=Σₖ₌₁^{k}αₖØₖ(t) formula I

wherein, Øₖ (t) is a basis function used for generating a curve X(t|Z), αₖ is a basis coefficient with respect to Øₖ (t), wherein αₖ(Z) is determined by covariates Z, and

b3. viewing αₖ a function αₖ (Z) of Z and rewriting formula I to formula I-1,

X(t|Z)=Σₖ₌₁^{K}αₖ(Z) Øₖ(t) formula I-1,

b4. providing n product sales values and a varible Zᵢ which may affect sales,

Xᵢ(t|Zᵢ)=Σₖ₌₁^{K}α_{t,k}(Zᵢ) Øₖ(t), i=1,2, . . . , n. formula II

finding Øₖ (t) in formula II by using autoedcoder to decompose \tilde{X}=(\tilde{X}ᵢⱼ),

representing Øₖ (t) by \hat{Ø}ₖ(t),

b5. obtain the value of α_{i,k} (Zᵢ) by formula III,

min f(Xᵢ(t|Zᵢ)−Σₖ₌₁^{K}α_{i,k}(Zᵢ)\hat{Ø}ₖ(t))²dt formula III

$${min}_{{α}_{i} , … , {α}_{k}} \int {( {X}_{i} ( t \vert {Z}_{i} ) - {\sum }_{k = 1}^{K} {α}_{i , k} ( {Z}_{i} ) {\hat{∅}}_{k} ( t ) )}^{2} dt \qquad formula III$$

representing α_{i,k}(Zᵢ) by \hat{α}_{i,k}(Zᵢ), and b6, estimating the relationship between \hat{α}_{i,k}(Zᵢ) and Zᵢ by a nonparametric regression model, after calculation finding the relationship between αₖ and Z, wherein [symbol] i [symbol] n; C. providing a calculation module for calculating sales data: c1. substituting the covariates Z of the product to be forecasted to forecast coefficients \hat{α}ₖ of the product, and c2. providing a formula IV for calculating forecast sales data of the product to be forecasted

Σₖ₌₁^{K}\hat{α}ₖ\hat{Ø}ₖ(t) formula IV

wherein αₖ is âₖ; and

D. providing an output module for outputting the sales data of the product to be forecasted.

In one embodiment, wherein the product is a cellular phone or a box office movie.

In one embodiment, wherein the product is the box office movie.

In one preferred embodiment, the covariates Z comprise budget, number of awards, rotten tomato index obtained from rottentomatoes.com (including average score, number of reviews, fresh (positive), rotten (negative) ratings, audience scores, including average score and user scores), IMDb scores, Metascore, and number of ratings. In another preferred embodiment, wherein the covariates Z comprise daily box office result, ranking, rated scores, number of users submitting scores, number of ratings, release date as database, to learn the basis function of product sales time of formula 1.

In one embodiment, wherein the major characteristics are estimated by a statistical component analysis method or an autoencoder.

In one embodiment, the statistical component analysis method is principal component analysis.

In one embodiment, wherein the major characteristics are estimated by singular value decomposition or nonnegative matrix factorization.

In one embodiment, wherein the coefficients (\hat{α}ₖ) of the product for forecasting is estimated according to a fitted sparse single-index model.

In one embodiment, wherein the nonparametric regression model is local polynomial regression or support vector regression.

The present invention also provides a system for forecasting producing sales data on a model-free prediction basis, which is characterized by comprising: A. a database used for: for storing records of historical sales data and a variety of variates of previous similar products, and B. a preprocessing module used for: b1. finding major characteristics of sales data from the historical sales data and corresponding variety of variates thereof of the previous similar products stored in the database, and b2. optimizing the major characteristics and coefficients thereof by using statistical optimization; C. a module for calculating forecast data used for: c1. substituting covariates of a product to be forecasted to calculate coefficients of the product to be forecasted, and c2. totalizing the sum of the coefficients of the product to be forecasted multiplied by the optimized major characteristics to forecast the sales data of the product to be forecasted; and D. an output module used for outputting the sales data of the product to be forecasted.

In one embodiment, the historical sales data are true data.

In one embodiment, wherein the major characteristics are estimated by a statistical component analysis method or an autoencoder.

In one embodiment, wherein the statistical component analysis method is principal component analysis.

In one embodiment, wherein the major characteristics are estimated by singular value decomposition or nonnegative matrix factorization.

In one embodiment, wherein the statistical optimization is an estimation of basis pursuit or a nonparametric regression model.

In another embodiment, wherein the nonparametric regression model is local polynomial regression or support vector regression.

In one embodiment, wherein the coefficients of the product to be forecasted is estimated according to a fitted sparse single indexed model.

The present invention is based on patterns of other similar products sales data, and then utilizes these patterns in combination with other market survey results to forecast sales conditions of new products, in turn marketing strategies of the products to be sold can be adjusted in time to comply with market demand, or even to create further demand to increase product sales.

The difference between the present invention and prior arts lies in that the prior arts require assumption sales models from a known mathematical model, for example the Bass diffusion model, etc. However, each model has its own assumptions and limitations, for example, the Bath diffusion model assumes that each individual can purchase one product for one time only. In reality, it is difficult for product sales to be in compliance with the model assumptions of known models. Therefore, it is difficult to get satisfactory forecasts by utilizing these models to forecast product sales data.

The present invention solves this drawback of the prior arts by utilizing true historical sales data of similar products to find sales data patterns of similar products, and then these patterns are utilized in combination with other market survey results to predict sales condition of new products. The advantages of this technique are that assumption models that constrain consumers' consumption patterns are no longer necessary, as a result, more accurate sales forecast results can be obtained.

The present invention develops an automatic encoding/decoding orthonormal pattern for expressing sales activities. Once such a pattern is developed, sales curve can be presented by a combination of these models and the future sales can be forecasted by non-parametric regression.

A method for forecasting product sales on a model-free prediction basis, comprising:

providing historical sales values X and a variety of variates of previous similar products,

finding major variates from the historical sales records and the variety of variates of the previous similar products by using a statistical component analysis method

providing formula I,

X(t|Z)=Σₖ₌₁^{K}αₖØₖ(t) formula I

wherein, Øₖ (t) is a basis function used for generating a curve X(t|Z), αₖ is a basis function with respect to Øₖ (t), wherein αₖ (Z) is determined by covariates Z,

viewing αₖ as the function αₖ of Z and rewriting formula I to formula I-1,

X(t|Z)=Σₖ₌₁^{K}αₖ(Z) Øₖ(t) formula I-1,

providing n product sales values and a variable Zᵢ which may affect sales,

Xᵢ(t|Zᵢ)=Σₖ₌₁^{K}α_{i,k}(Zᵢ) Øₖ(t), i=1,2, . . . , n. formula II

finding α_{i,k} and Øₖ (t) in formula II by using nonnegative matrix decomposition of \tilde{X}=(\tilde{X}ᵢⱼ), and representing α_{i,k}and Øₖ (t) by â_{i,k} and \hat{Ø}ₖ(t), respectively,

obtaining the value of α_{i,k} (Zᵢ) by formula III,

$${min}_{{α}_{i} , … , {α}_{k}} \int {( {X}_{i} ( t \vert {Z}_{i} ) - {\sum }_{k = 1}^{K} {α}_{i , k} ( {Z}_{i} ) {\hat{∅}}_{k} ( t ) )}^{2} dt \qquad formula III$$

estimating the relationship between αi,k (Zi) and Zi by a nonparametric regression model,

finding the relationship between αₖ and Z, wherein 1 [symbol] i

[symbol]

substituting the covariates Z of the product to be forecasted to forecast coefficients \hat{α}ₖ of the product, and

providing a formula IV to obtain forecast sales of the product to be forecasted,

Σₖ₌₁^{K}\hat{α}ₖ\hat{Ø}ₖ(t) formula IV

wherein αₖ is \hat{α}ₖ.

The term “covariates” as used herein refers to the covariates of variables in sales activities that is influential on sales or capable of influencing sales.

When X(t|Z) represents a sales curve at time t, Z is several covariates Z =(z₁, z₂, . . . , zₚ)′ that have effects on sales activities. Since most sales curves have similar shapes, such as monotone decreasing, bell shape, S-curve, etc. It is reasonable to assume that X(t|Z) can be expressed by a fixed number of orthogonal basis functions. Therefore, firstly, it is assumed that

X(t|Z)=Σₖ₌₁^{K}αₖ(Z) Øₖ(t) formula I;

wherein Øₖ (t) are basis functions used for generating a curve X(t|Z), αₖ(Z) are basis functions with respect to basis coefficients Øₖ (t), wherein αₖ(Z) may be determined by the covariates Z. It should be noted that there is no correlation among each αₖ(Z) because Øₖ (t) are orthogonal. Øₖ (t) is one pattern (or characteristic) of various possible sales curves. However, unlike previous explicit formula that predetermines a curve pattern based on some specific assumptions of sales activities, the present invention determines this pattern based on historical sales data, which is described below.

Assuming from a database which contains historical sales curves of n products (i.e., X₁(t|Z₁), X₂(t|Z₂), . . . , Xₙ(t|Zₙ)

Xᵢ(t|Zᵢ)=Σₖ₌₁^{K}α_{i,k}(Zᵢ) Øₖ(t), i=1,2, . . . , n. formula II.

With assumption formula II, the basis functions ϕk(t) in formula I can be estimated from the database by, for example, functional versions of singular value decomposition, nonnegative matrix decomposition, etc. Once Øₖ (t)'s are estimated (represented by \hat{Ø}ₖ (t)), coefficients α_{i,k} (Zᵢ) (represented by \hat{α}_{i,k} (Zᵢ)) can in turn be obtained by solving, for example, formula III,

$${min}_{{α}_{i} , … , {α}_{k}} \int {( {X}_{i} ( t \vert {Z}_{i} ) - {\sum }_{k = 1}^{K} {α}_{i , k} ( {Z}_{i} ) {∅}_{k} ( t ) )}^{2} dt . \qquad formula III$$

After Øₖ (t) and α_{i,k} (Zi) are estimated by \hat{Ø}ₖ (t) and α_{i,k} (Zi), respectively, the present invention can display the historical sales curves of n by corresponding to the basis coefficients of n âi,k(Zi).

The coefficients \hat{α}i,k (Zi) may be determined by the covariate Zi, and Zi may be unknown at the time of operation. The present invention estimates the relationship between \hat{α}i,k (Zi) and Zi by using a nonparametric regression model such as local polynomial regression (Fan et al., 1996), support vector regression (Drucker et al., 1997), rather than specifically pointing out the explicit formulation of relationship between âi,k (Zi) and Zi. When the covariates Z are unknown, several candidate covariates can be provided and true variates can be selected through variable selection procedures, for example, local polynomial regression (Miller et al., 2010 (Local polynomial regression and variable selection, Volume Volume 6 of Collections, pp. 216-233. Beachwood, Ohio, USA: Institute of Mathematical Statistics), sparse support vector machine (Bi et al., 2003, Dimensionality Reduction via Sparse Support Vector Machines 3, 1229-1243), sparse sufficient dimension reduction (Li 2007 Sparse sufficient dimension reduction. Biometrika 94, 603-613).

### BRIEF DESCRIPTION OF THE DRAWINGS

FIG. 1 is a flow chart of one embodiment of the method of the present invention.

FIG. 2 shows the daily total revenue and projected total revenue of the movie “Taken 3.”

FIG. 3 shows the daily total revenue and projected total revenue of the movie “The Last Five Years.”

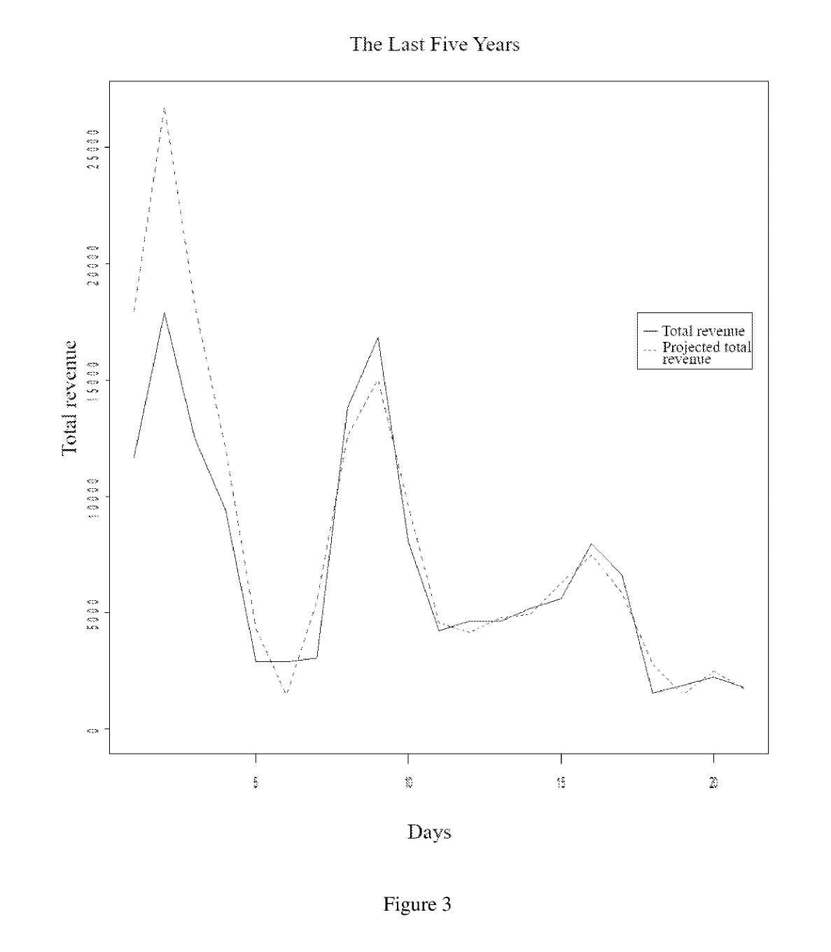

### EXAMPLES

The following, in combination with the drawings of the embodiments of the present invention, describes clearly and completely the technical solutions involved in the embodiments of the present invention. Apparently, the described embodiments are merely some but not all embodiments of the present invention. All other embodiments obtained by a person of ordinary skill in the art based on the embodiments of the present invention without creative efforts shall fall within the protection scope of the present invention.

In one embodiment, the present invention was validated by using daily box office forecasts. Daily box office results, rankings, rated ratings, number of users submitting scores, number of reviews, release dates, etc. from 2013 to 2014 were collected to be used as the database to train the basis functions and other unknown items of the model of the present invention. Movies released in 2015 were used for validation. Two movies were used in this example to present the predictive accuracy of the present invention: “Taken 3” (release date: May 14, 2015) and “Last Five Years” (release date: March 05, 2015).

The box office results of the movie number i at day tᵢⱼ; wherein Xᵢⱼ=Xᵢ (tᵢⱼ),

$${max}_{i} 1 \leq {t}_{ij} \leq {T}_{i} .$$

When T=Ti and Zᵢ were set to be the covariates of the movie number i; the covariates comprised budget, number of awards, Rotten Tomato index taken from rottentomatoes.com (including average score of the movie, number of reviews, fresh (positive), rotten (negative) ratings, audience scores, including average score and user scores), IMDb scores, Metascore, and number of ratings.

Steps: 1. Xᵢⱼ was displayed as follows:

$${\tilde{X}}_{ij} = \{ \begin{matrix}{X}_{i} ( {t}_{ij} ) , 1 \leq {t}_{ij} \leq {T}_{i} \\ 0 , {T}_{i} < {t}_{ij} \leq T\end{matrix} .$$

2. α_{i,k} and Øₖ (t) in formulat II were found by using nonnegative matrix decomposition of \tilde{X}=(\tilde{X}ᵢⱼ) (Berry et al.,, 2007, Algorithms and applications for approximate nonnegative matrix factorization. Computational Statistics and Data Analysis 52, 155-173). α_{i,k} and Øₖ (t) were respectively represented by â_{i,k} and \hat{Ø}ₖ(t).

3. The relationship between aₖ and Z was found by using a fitted sparse single indexed model (Alquier et al., 2013, Sparse single-index model. Journal of Machine Learning Research 14, 243-280.), wherein 1≤i≤n;

4. A new movie was forecasted: review Z of the movie was substituted into the fitted sparse single indexed model in step 3 to forecast the coefficients aₖ of the movie. Aₖ was set to be \hat{α}ₖ; the box office forecast of the movie could be obtained by the following formula:

Σₖ₌₁^{K}\hat{α}ₖ\hat{Ø}ₖ(t).

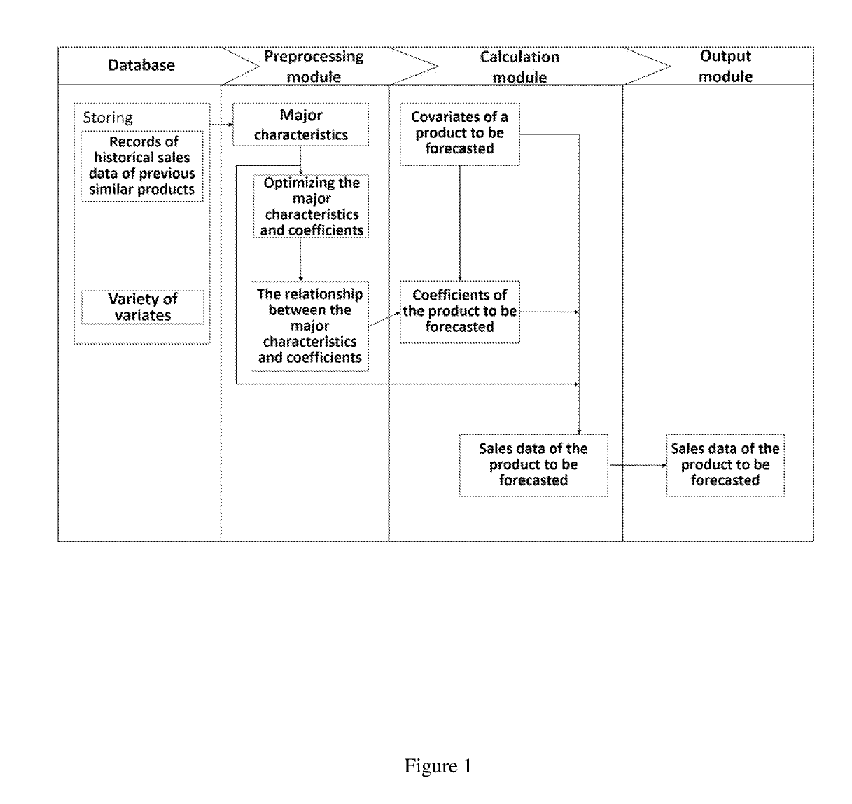

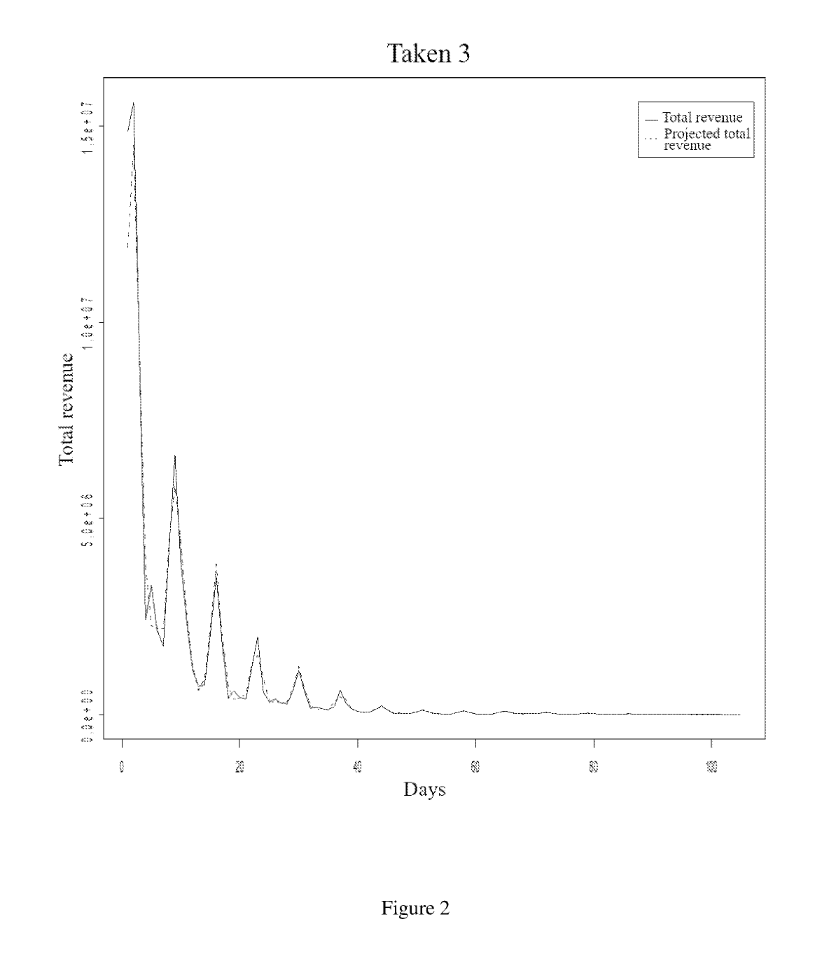

The ratings of “Taken 3” and “Last Five Years” were very similar. However, the total revenue of Taken 3 was significantly higher than that of Last Five Years. The graphs of the actual total revenue and the total revenue projected by the present invention were shown in FIGS. 1 and 2. Based on these two figures, it could be learned that the forecasting model of the present invention were substantially fairly and accurately applied to these two films.

One of ordinary skill in the art would readily appreciate that all or part of the processes used to implement the methods of the aforementioned embodiments may be performed by a relevant hardware instructed by a computer program. The program may be stored in a computer-readable storage medium. When being executed, the program may include the procedures of each aforementioned embodiment of the method, wherein the storage medium may be a magnetic disk, an optical disk, a Read-Only Memory (ROM) or a Random Access Memory (RAM), etc.

The above description is preferred embodiments of the present invention. It should be noticed that one skilled in the art may modify and vary the examples without departing from the spirit and scope of the present invention, therefore, these improvements and modifications should be construed as within the scope to be protection of the present invention.

What is claimed is:

1. A method for forecasting product sales data on a model-free prediction basis, which is characterized by comprising:
A. establishing a database for storing records of historical sales data and a variety of variates of previous similar products,
B. providing a preprocessing module for processing:
b1. finding major characteristics of sales data from the historical sales data of previous similar products and corresponding variety of variates thereof of the previous similar products stored in the database, and
b2. optimizing the major characteristics and coefficients thereof by using statistical optimization;
C. providing a calculation module for calculating forecast data:
c1. substituting covariates of a product to be forecasted to calculate coefficients of the product to be forecasted, and
c2. totalizing the sum of the coefficients of the product to be forecasted multiplied by the optimized major characteristics to forecast sales data of the product to be forecasted; and
D. providing an output module for outputting the sales data of the product to be forecasted.

2. The method for forecasting product sales data on a model-free prediction basis according to claim 1, which is characterized in that the historical sales data are true data.

3. The method for forecasting product sales data on a model-free prediction basis according to claim 1, which is characterized in that the major characteristics are estimated by a statistical component analysis method or an autoencoder.

4. The method for forecasting product sales data on a model-free prediction basis according to claim 3, which is characterized in that the statistical component analysis method is a principal component analysis.

5. The method for forecasting product sales data on a model-free prediction basis according to claim 1, which is characterized in that the major characteristics are estimated by singular value decomposition or nonnegative matrix factorization.

6. The method for forecasting product sales data on a model-free prediction basis according to claim 1, which is characterized in that the statistical optimization is an estimation of Basis pursuit or a nonparametric regression model.

7. The method for forecasting product sales data on a model-free prediction basis according to claim 6, which is characterized in that the nonparametric regression model is local polynomial regression or support vector regression.

8. The method for forecasting product sales data on a model-free prediction basis according to claim 1, which is characterized in that the coefficients of the product to be forecasted are estimated according to a fitted sparse single-index model.

9. A method for forecasting product sales data on a model-free prediction basis, which is characterized by comprising:
A. establishing a database for storing historical sales values X and a variety of variates of previous similar products, and
B. providing a preprocessing module for processing:
b1. finding major characteristics from records of the historical sales values X and the variety of variates Z of the previous similar products stored in the database,
b2. providing an equation of formula I,
X(t|Z)=Σₖ₌₁^{K}αₖØₖ(t) formula I
wherein, Øₖ (t) is a basis function used for generating a curve X(t|Z), αₖ is a basis coefficient with respect to Øₖ(t), wherein αₖ(Z) is determined by covarites Z,
b3. viewing αₖ as a function αₖ (Z) of Z and rewriting formula I to formula I-1,
X(t|Z)=Σₖ₌₁^{K}αₖ(Z) Øₖ(t) formula I-1,
b4. providing n product sales values and a variable Zᵢ which may affect sales,
Xᵢ(t|Zᵢ)=Σₖ₌₁^{K}α_{i,k}(Zᵢ) Øₖ(t), i=1,2, . . . , n. formula II
finding Øₖ (t) in formula II by using an autoencoder to decompose \tilde{X}=(\tilde{X}ᵢⱼ), and representing Øₖ (t) by Øₖ(t),
b5. obtaining the value of α_{i,k} (Zᵢ) by formula III,
$${min}_{{α}_{i} , … , {α}_{k}} \int {( {X}_{i} ( t \vert {Z}_{i} ) - {\sum }_{k = 1}^{K} {α}_{i , k} ( {Z}_{i} ) {\hat{∅}}_{k} ( t ) )}^{2} dt \qquad formula III$$
representing α_{i,k} (Zᵢ) by \hat{α}_{i,k} (Zᵢ) and
b6. estimating the relationship between â_{i,k}(Zᵢ)and Zᵢ by a nonparametric regression model, after calculation finding the relationship between aₖ and Z, wherein 1 [symbol] i [symbol] n;
C. providing a calculation module for calculating sales data:
c1. substituting the covariates Z of the product to be forecasted to forecast coefficients \hat{α}ₖ of the product to be forecasted, and
c2. providing a formula IV for calculating forecast sales data of the product to be forecasted
Σₖ₌₁^{K}\hat{α}ₖ\hat{Ø}ₖ(t) formula IV
wherein αₖ is âₖ; and,
D. providing an output module for outputting the sales data of the product to be forecasted.

10. The method for forecasting product sales data on a model-free prediction basis according to claim 9, which is characterized in that the product is a cellular phone or a box office movie.

11. The method for forecasting product sales data on a model-free prediction basis according to claim 9, which is characterized in that the product is the box office movie.

12. The method for forecasting product sales data on a model-free prediction basis according to claim 11, which is characterized in that the covariates Z comprise budget, number of awards, rotten tomato index obtained from rottentomatoes.com (including average score, number of reviews, fresh (positive), rotten (negative) ratings, audience scores, including average score and user scores), IMDb scores, Metascore, and number of ratings.

13. The method for forecasting product sales data on a model-free prediction basis according to claim 11, which is characterized in that the covariates Z comprise daily box office result, ranking, rated scores, number of users submitting scores, number of ratings, release date as database, to learn the basis function of product sales time of formula 1.

14. The method for forecasting product sales data on a model-free prediction basis according to claim 9, which is characterized in that the major characteristics are estimated by a statistical component analysis method or an autoencoder.

15. The method for forecasting product sales data on a model-free prediction basis according to claim 14, which is characterized in that the statistical component analysis method is principal component analysis.

16. The method for forecasting product sales data on a model-free prediction basis according to claim 9, which is characterized in that the major characteristics are estimated by a singular value decomposition method or a nonnegative matrix factorization method.

17. The method for forecasting product sales data on a model-free prediction basis according to claim 9, which is characterized in that the coefficients (\hat{α}ₖ) of the product to be forecasted is estimated according to a fitted sparse single-index model.

18. The method for forecasting product sales data on a model-free prediction basis according to claim 9, which is characterized in that the nonparametric regression model is deep learning, local polynomial regression or support vector regression.

19. A system for forecasting product sales data on a model-free prediction basis, which is characterized by comprising:
A. a database used for: for storing records of historical sales data and a variety of variates of previous similar products, and
B. a preprocessing module used for:
b1. finding major characteristics of sales data from the historical sales data and corresponding variety of variates thereof of the previous similar products stored in the database, and
b2. optimizing the major characteristics and coefficients thereof by using statistical optimization;
C. a module for calculating forecast data used for:
c1. substituting covariates of a product to be forecasted to calculate the coefficients of the product to be forecasted, and
c2. totalizing the sum of the coefficients of the product to be forecasted multiplied by the optimized major characteristics to forecast the sales data of the product to be forecasted; and
D. an output module used for outputting the sales data of the product to be forecasted.

20. The system for forecasting product sales data on a model-free prediction basis according to claim 19, which is characterized in that the historical sales data are true data.

21. The system for forecasting product sales data on a model-free prediction basis according to claim 19, which is characterized in that the major characteristics are estimated by a statistical component analysis method or an autoencoder.

22. The system system for forecasting product sales data on a model-free prediction basis according to claim 19, which is characterized in that the statistical component analysis method is principal component analysis.

23. The system for forecasting product sales data on a model-free prediction basis according to claim 19, which is characterized in that the major characteristics are estimated by a singular value decomposition method or a nonnegative matrix factorization method.

24. The system for forecasting product sales data on a model-free prediction basis according to claim 19, which is characterized in that the statistical optimization method is an estimation of basis pursuit or a nonparametric regression model.

25. The system for forecasting product sales data on a model-free prediction basis according to claim 24, which is characterized in that the nonparametric regression model is local polynomial regression or support vector regression.

26. The system for forecasting product sales data on a model-free prediction basis according to claim 19, which is characterized in that the coefficients of the product to be forcasted is estimated according to a fitted sparse single-index model.
